(19) United States
(12) Patent Application Publication
(10) Pub. No.: US 2004/0015270 A1
(43) Pub. Date: Jan. 22, 2004

(54) Interactive irrigation system

(76) Inventors: John W. Addink, Riverside, CA (US); Kirk Buhler, Corona, CA (US)

Correspondence Address: Rutan & Tucker, LLP, 14th Floor, 611 Anton Blvd., Costa Mesa, CA, 92626, US

(21) Appl. No.: 10/360,157

(22) Filed: Jun. 6, 2003

Related U.S. Application Data
(63) Continuation-in-part of application No. 10/104,224, filed on Mar. 21, 2002.

(51) Int. Cl. G05B 19/18; G05B 11/01

(52) U.S. Cl. 700/284; 700/19

(57) ABSTRACT

An interactive irrigation system exchanges information between an irrigation controller and a distal computer and between the distal computer and a third party. The user can exchange information with the irrigation controller and the distal computer. The information is preferably exchanged over an Internet communication system. The exchanged information includes the following: irrigation scheduling; quantity of water applied to the irrigated area at the user location, which is compared to ET values; warnings to users when potential problems with their irrigation systems are detected; and other irrigation information that is useful to the user or a third party.

This application is a Continuation-In-Part of U.S. patent application Ser. No. 10/104,224 filed on Mar. 21, 2002, which claims priority to application number PCT/US00/22673 filed Aug. 17, 2000, and claims priority to U.S. application Ser. No. 10/031,046 filed Jan. 10, 2002, all incorporated herein by reference in their entirety.

### FIELD OF THE INVENTION

The field of the invention is irrigation systems.

### BACKGROUND OF THE INVENTION

In arid areas of the world water is becoming one of the most precious natural resources. Meeting future water needs in these arid areas will require aggressive conservation measures. This in turn requires irrigation systems that apply water to the irrigated area based on the water requirements of the plants. Many irrigation controllers have been developed for automatically controlling applications of water to irrigated areas. Known irrigation controllers range from simple devices that control watering times based upon fixed schedules, to sophisticated devices that vary the watering schedules according to local geographic and climatic conditions.

With respect to the simpler types of irrigation controllers, a homeowner typically sets a watering schedule that involves specific run times and days for each of a plurality of irrigated areas. The irrigation controller executes the same schedule regardless of the season or weather conditions. From time to time the homeowner may manually adjust the watering schedule, but such adjustments are usually only made a few times during the year, and are based upon the homeowner's perceptions rather than the actual watering needs of the plants. One change is often made in the late spring when a portion of the yard becomes brown due to a lack of water. Another change is often made in the late fall when the homeowner assumes that the vegetation does not require as much watering. These changes to the watering schedule are typically insufficient to achieve efficient watering.

More sophisticated irrigation controllers usually include some mechanism for automatically making adjustments to the irrigation run times to account for daily environmental variations. However, due to the complexity of these irrigation controllers, the homeowner makes few, if any changes, to the irrigation controller settings. Furthermore, the homeowner may not even check if the irrigation controller is operating properly unless the irrigated plant material begins browning and/or dying.

Additionally, since these irrigation controllers automatically operate the irrigation system,the homeowner makes no preparation for someone to check the system when they are absent from their residence for an extended period of time, such as on a vacation. The irrigation controller is just a machine and for any number of reasons the irrigation controller may not continue to operate correctly, such as if the electricity to the residence is temporarily turned off.

Because of user disinterest and/or lack of knowledge in the operation of present automatic irrigation systems, there exists a need for a cost-effective methods and devices to assist the irrigation user in attaining more efficient irrigation and more consistent monitoring of the irrigation system.

There are irrigation systems that are entirely or partly controlled by a distal computer that is located at a remote site from the irrigation controller. One such system, disclosed in U.S. Pat. No. 5,208,855, issued May 1993, to Marian, broadcasts potential evapotranspiration (ET) values for multiple geographic zones. Irrigation controllers receive and extract appropriate data for the local conditions, and then use the extracted data to calculate run times. However, there is no regular monitoring, other than by the user, of whether the irrigation controllers actually utilized and modified the irrigation schedule based on the broadcast ET values. Another irrigation system described in U.S. Pat. No. 5,696,671, issued December 1997, and U.S. Pat. No. 5,870,302, issued Febuary 1999, both to Oliver, uses a central computer to compute a watering factor that is sent to the irrigation site to modify the watering schedule at the site. The watering factor is partially based on information the central computer receives from the irrigation site. As with the above patent, so also with this patent, there is no monitoring to ensure that the irrigation controller is applying the information transmitted from the central computer.

A large irrigation system described in U.S. Pat. No. 5,479,339, issued December 1995 to Miller, has management personnel remotely located and users located at the irrigation site. Information is transmitted from the irrigation site to management personnel so they can monitor the quantity of water that is applied at the irrigation site. Irrigation systems such as the one taught by Miller are either too large or cost prohibitive for use on residential sites and smaller commercial irrigated sites. In addition, none of the known irrigation systems communicate with the user with respect to operating efficiency, and/or provide the user with specific information on improving such efficiency.

Computers at remote locations are being used to control some types of devices. One such system described in U.S. Pat. No. 6,053,844, issued April 2000 to Clem, uses a computer at a remote site to directly control a fitness device via an Internet system. The user of the fitness device can also interact on-line with a fitness expert to engage in real time two-way communications.

What is still needed is application of remote control concepts to the field of irrigation. In particular, there is a need for systems and methods in which a distal computer, remote from the user's location, monitors the operation of the irrigation system, to assist an irrigation user in attaining more efficient irrigation of the irrigated area. What is especially needed are systems and methods in which the distal computer communicates over the Internet with an irrigation controller at the user's site and with a third party.

### SUMMARY OF THE INVENTION

An irrigation system exchanges information between an irrigation controller and a distal computer and between the distal computer and a third party. Additionally, in a preferred embodiment of the present invention, the user can exchange information with the irrigation controller and the distal computer.

In a preferred embodiment, at least one of the first or second communication systems comprises a public, packet switched network such as the Internet and such network may temporally include the distal computer. Alternatively, it is contemplated that the communication systems may transfer information by telephone, radio waves, two-way pager, infra-red, light, sound, or any other suitable communication means. Preferably, exchange of information is bid-directional but may be unidirectional.

The water application devices may be residential, agricultural, horticultural, or any other water application devices.

In especially preferred embodiments, microprocessors are disposed in the irrigation controller and the distal computer and are programmed for transmitting information, receiving information, and at least partially controlling the operation of the irrigation controller. Additionally, a microprocessor may be disposed in a second unit separate from the irrigation controller that facilitates the exchange of information between the irrigation controller and the distal computer. Preferred embodiments also include a storage device in the controller, such as a nonvolatile memory, for the storing of data.

The information transmitted between the irrigation controller and the distal computer, between the distal computer and a third party or between the user and either or both of the irrigation controller and distal computer may advantageously include water usage data, weather data, ET data, crop coefficient values, irrigation efficiency values and so forth. ET values may be provided to the irrigation controller, or calculated or estimated by the microprocessor disposed in the irrigation controller. Alternatively, the microprocessor disposed in the distal computer, may calculate or estimate the ET value.

The microprocessor disposed in the controller may advantageously be programmed to detect problems with the irrigation system. This is preferably accomplished by pre-setting one or more parameters within which the irrigation system should operate. If the operation of the irrigation system falls outside of the parameters, a warning may be sounded to the user, distal computer, or third party. If potentially severe problems are detected, one or more operations of the irrigation system may be shut down.

In yet another preferred aspect, the user may be able to obtain information, regarding the irrigation system, from the distal computer. Such Information may include operating parameters such as irrigation run times, irrigation water flow data, irrigation water pressure data, and computed information such as computed ET, total water applied to the irrigated area during a specified time period, percent of ET actually applied, and educational information on water conservation. Similar information may be made available to a water district or other third party.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a listing of two communication systems described in the specification.

FIG. 2 is a schematic representation of an interactive irrigation system according to the present invention.

FIG. 3 is a schematic of an irrigation controller.

### Detailed Description

As used herein, an “irrigation system” includes underground, solid set, linear move, center pivot, and all other types of irrigation systems. The term “irrigation controller” indicates a physical device that controls operation of one or more water application devices according to an irrigation schedule. “Water application devices” are physical devices that apply water to irrigated areas (e.g. sprinklers, bubblers, drippers, sprayers, and so forth.) “Water application devices” can be residential water application devices, agricultural water application devices, horticultural application devices, and so forth. The term “distal computer” is used herein to mean a computer that is remote from the user's site but is connected to and provides the means for storage and communication of information to and from the irrigation controller, a third party and/or a user. A distal computer is preferably located at least 1 km from the user's site. The term “user” means a natural person who has at least some interaction with the irrigation controller and is situated locally (e.g. within 20 meters) to the controller during a relevant time period. The term “user” may include the owner of the irrgation system, the operator of the irrigation system and so forth. The term “third party” is used herein to mean a legal person other than the user. A third party need not be a physical person, and may well be a water district or other government agency. The third party will generally not be directly involved with the operation of the irrigation controller but may influence which irrigation schedules are executed by the irrigation controller.

The term “communication system” is used in a very broad sense herein to mean any system used to communicate information. Contemplated communication systems may be analog or digital. Information communication can be wired or wireless and can include one or more of the following: telephone, radio, two-way pagers, infra-red, light, and sound. Networks can be packet switched or not, involve dedicated or non-dedicated lines, may be public or private, or any combination of these. Bi-directional communication systems may or may not be duplex (i.e. carrying signals in both directions at the same time). Contemplated communication systems may use any appropriate hardware. For example, communication between an irrigation controller and a user may employ a key pad for entering data into the irrigation controller, and an LED display for transmitting information from the irrigation controller to the user. Alternatively, sound may be used, such as where a user provides information to the irrigation controller using voice and the irrigation controller communicates to the user using synthesized speech. In yet other embodiments, a user may communicate with an irrigation controller located in the garage of a personal residence, through a personal computer (PC) type keyboard and display screen located in an office of the residence. In yet another embodiment, a user may communicate with an irrigation controller located in an agricultural field through a personal computer located in a house, office, vehicle, and so forth. The link may be hard wired, or it may utilize any other suitable connection, such as telephone, radio, two-way pager, and public, packet switched network known as the Internet. Storage devices may again be any suitable information storage, including hard drive, floppy disk, RAM, ROM, and so forth.

The term “personal computer” or “computer” means any computing device that is suitable for performing the functions described herein including a desk top model, a lap top, notebook, personal digital assistant, (e.g. Palm Pilot™) phone, telematics device, set-top device, and so on.

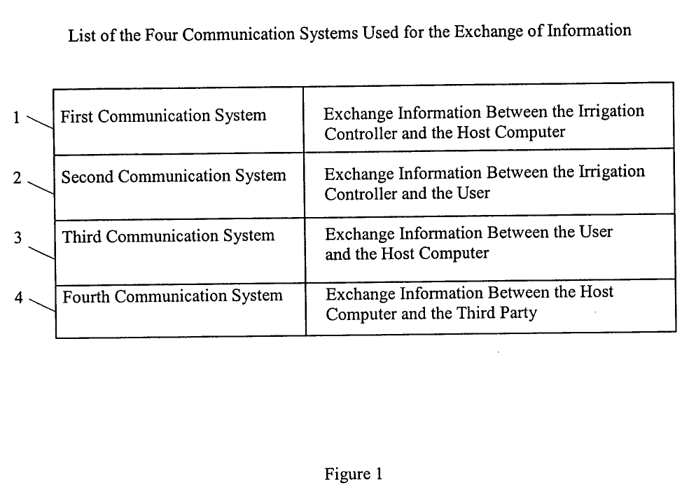

FIG. 1 shows two communication systems that exchange information in preferred embodiments of the present invention. The first communication system 1 exchanges information between an irrigation controller and a distal computer. The second communication system 2 exchanges information between the distal computer and a third party. Each of these communication systems are preferably bi-directional but may be unidirectional. Any suitable communication language can be used to communicate information across any of the communication systems.

In a preferred embodiment of the present invention, a user may also exchange information with either one or both, the irrigation controller and the distal computer.

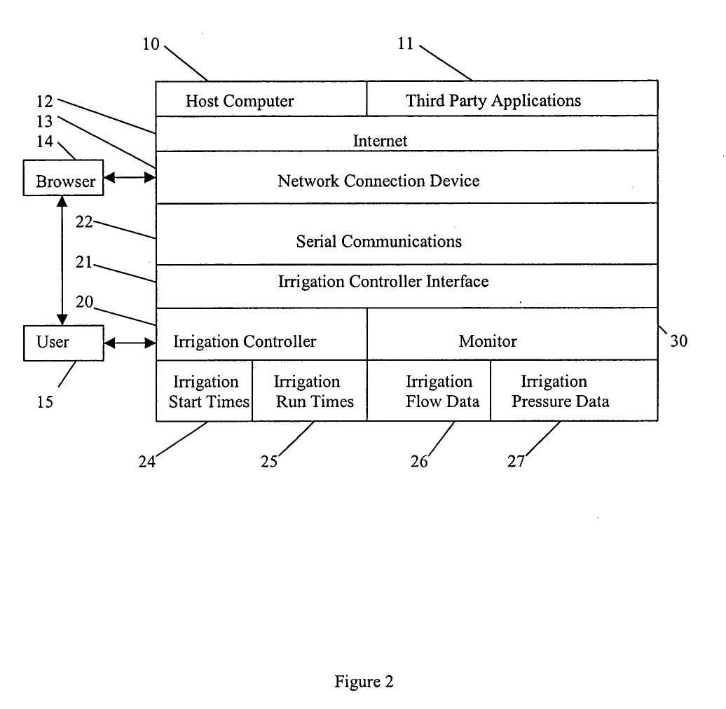

FIG. 2 is a schematic representation of an interactive irrigation system according to the present invention. A distal computer 10 is interactively connected to an irrigation controller 20 via the first communication system 1, FIG. 1. The first communication system 1 and second communication system 2 preferably comprise a public packet switched network (e.g. the Internet) that may include a telephone system, a radio system, a pager system, two-way pager system, a wide area network, or any other suitable communication system. An irrigation controller interface 21, FIG. 2 is provided for coupling the irrigation controller 20 to a network connection device 13. The network connection device 13 can be a network computer, a personal computer, a set-top box, or any other suitable connection device. Information is preferably transmitted between the irrigation controller interface 21 and the network connection device 13 through a serial communication channel 22.

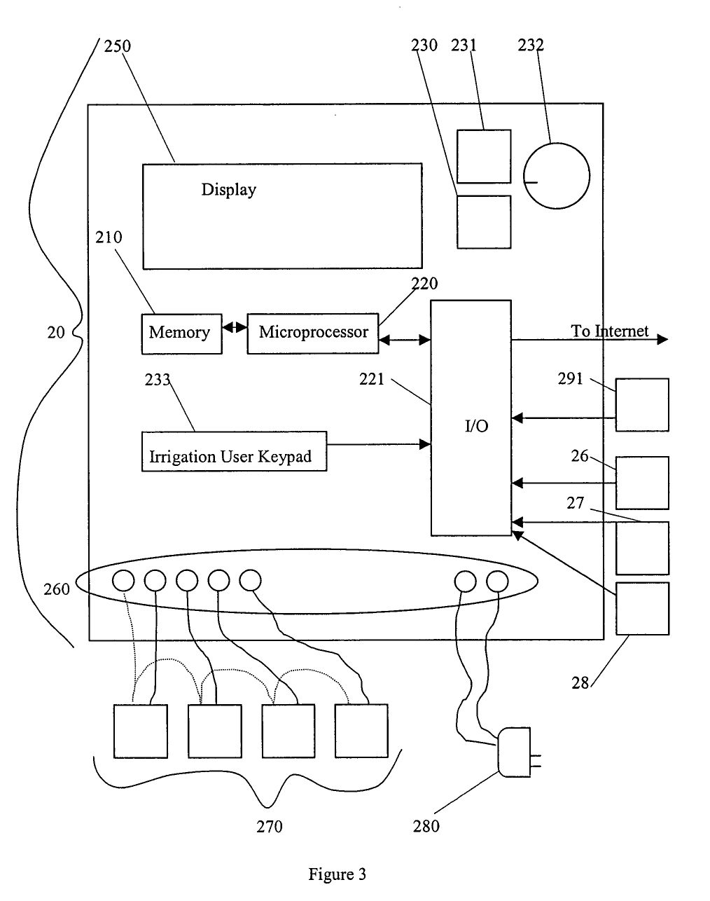

The first communication system 1, FIG. 1 permits the distal computer 10, FIG. 2 to transmit control information to the irrigation controller 20. The control information may include irrigation start times 24, irrigation run times 25, and contingency rules. Contingency rules are generally comprised of an event or condition followed by an associated instruction should the event occur or the condition occur or be satisfied. For example, if the event is detection of an anomaly, the instruction may be to cease operation of the irrigation controller 20. On the other hand, if the event is the correction of a problem causing an anomaly, the instruction to the controller may be to resume operation. Other contemplated events and their associated instructions may be based on one or more of the following variables: weather conditions, water pressure, water conservation consideration (e.g. water application or run time thresholds), ETo values, limits on when irrigation will occur based on utility rates, and so on. For instance, it may be prudent to run an electric powered pump only at times when there is a low demand for electricity. The control information is preferably derived from information inputted, received and/or stored in the distal computer 10. The first communication system 1, FIG. 1 also permits the irrigation controller 20, FIG. 2 to transmit irrigation information to the distal computer 10. Such information may advantageously include irrigation water flow data 26 and water pressure data 27 (See also FIG. 3) as well as actual and expected water application values.

The second communication system 2, FIG. 1 is used to provide information to a third party. The information thus provided may include irrigation operating information such as irrigation start times 24, FIG. 2, irrigation run times 25, irrigation water flow data 26, irrigation water pressure data 27, total quantity of water applied to the irrigated area during a specified time period, and the percent the actual water applied to the irrigated area represents of the desired rate of application based at least in part on an ET value. Where the third party is a water district, this information could be used for billing purposes, monitoring purposes, scheduling purposes, or for many other uses. Educational information may travel from the third party 11 to the distal computer 10 and then on to the user 15, or from third party 11 directly to the user 15. Preferably a user communicates with an irrigation controller. Since both user 15 and controller 20 are local, this could advantageously be accomplished through a keypad 233 physically located on the irrigation controller 20 (See FIG. 3), or in some manner coupled to the controller 20. Other communication systems are, however, also contemplated. It is especially contemplated that the user 15 could communicate with the irrigation controller 20 using a desktop computer, laptop computer, hand-held computer or PDA. Such embodiments may be well suited for a configuration where the irrigation controller 20 is in a garage or field, and the user 15 is operating the controller 20 from within a nearby house, office or vehicle. It is further contemplated that communication between the user and the irrigation controller may be accomplished using voice recognition and voice synthesis.

Preferably a user communicates with a distal computer via a public packet swtiched network such as the Internet, the wireless Internet, and a wide-area network. To this end, the user 15 may employ a computer, for example, a personal computer 13 with an Intel Pentium processor and a modem. An Internet browser 14 is preferably operational from the personal computer 13, and is used to provide interactive connection with the distal computer 10. It should be recognized that other types of public packet switched networks may be used including those that utilize a telephone, radio, set-top box and other suitable devices. Among other things, the user 15 may transfer irrigation operating information related to irrigated area size, drainage soil properties (e.g. percolation rate), crop information, crop coefficients, irrigation efficiencies, and so forth to the distal computer.

The distal computer 10 may advantageously combine irrigation operating information with additional information to derive an irrigation schedule to be downloaded into the irrigation controller 20. It can be appreciated that if a personal computer is used by the user 15 to communicate with the irrigation controller 20, irrigation information can be inputted into the user's personal computer. Subsequently, the user's personal computer may combine the irrigation operating information with additional information to derive an irrigation schedule to be downloaded into the irrigation controller 20 from the user's personal computer. It is further contemplated that the irrigation operating information along with additional information may be communicated to the irrigation controller 20. A microprocessor disposed in the irrigation controller 20, FIG. 2, can then derive an irrigation schedule that may be executed by the irrigation controller. Such additional information may include one or more of the following: daily weather data; historic ET values; daily irrigation water flow data 26; daily irrigation water pressure data 27; and other information that will provide for efficient irrigation applications. Historic ET values are generally reflective of a geographic area within a 30 mile radius of the irrigated site. Alternatively, historic ET values may be reflective of an area that has similar meteorological conditions as the irrigated site. In any case, historic ET values should approximate actual ET values at the irrigated site. It is especially contemplated that an irrigation schedule is designed to provide efficient irrigation of the irrigated area with a minimum waste of water. This may involve comparing a computed quantity of water that was applied to the irrigated area against an ET value for that irrigated area. Differences in these values may be stored, and made available to the user 15 and third parties 11 via the first and/or second communication system.

A user may use communicate with an irrigation controller using the distal computer 10, and/or a personal computer and such computer may also be programmed to detect problems with the irrigation system. This can be accomplished by setting parameters (e.g. thresholds) within which the irrigation system is determined to be operating effectively. If operation of the irrigation system falls outside of one or more of the parameters or exceeds a threshold, this could indicate that a problem with the irrigation system exists. For example, if the total quantity of water to be applied to the irrigated area during each scheduled irrigation is determined to be approximately 100 gallons, then upper and lower threshold parameters for total water application could be set at 90 gallons and 110 gallons, respectively. If the quantity of water applied during any scheduled irrigation was less than 90 gallons or greater than 110 gallons, it would be likely that a problem exists in some portion of the irrigation system. A lower than normal quantity of applied irrigation water could indicate plugged heads, and a higher than normal quantity of applied irrigation water could indicate broken irrigation lines, broken sprinkler heads, or excessive watering time. If problems with the irrigation system are detected, the user 15 may be warned by visible or audible signals, and/or control commands may be sent to the irrigation controller 20 to prevent the irrigation controller 20 from executing an irrigation schedule. Warnings may take the form of e-mails, alarm sounds, pager messages, and so on.

It is contemplated that environmental conditions at or near the irrigated site may be monitored and if environmental conditions are such that an irrigation application is not required or the environmental conditions would adversely affect the irrigation application the irrigation controller 20 will be prevented from executing the irrigation schedule. For instance, it would be advantageous to prevent execution of an irrigation schedule when it is raining, when there are high winds, and when there is relatively high soil moisture.

Due to cost considerations and other reasons, presently installed irrigation controllers may not be able to receive an irrigation schedule from the distal computer 10. In such cases, it is contemplated that the user 15 may obtain irrigation scheduling information from the distal computer 10 and subsequently program the irrigation controller 20 directly. One scenario is for the user 15 to access the irrigation schedule using a web browser 14 on a personal computer 13. The user may access a web site in order to obtain irrigation scheduling information provided by the distal computer 10. Such access can be protected by a user identification code, password, and other security measures. Additionally, an irrigation controller may utilize biometrics in order to achieve security as for example by having a finger print scanning device as part of the irrigation controller.

In FIG. 3, an irrigation controller 20 generally includes a microprocessor 220, an on-board memory 210, manual input devices 230 through 232 (e.g. buttons, knobs, a roller ball, etc . . . ), an irrigation user keypad 233 for entering irrigation identifying information, an input/output (I/O) circuitry 221 connected in a conventional manner, a display screen 250, electrical connectors 260 which are connected to a plurality of irrigation application devices 270 and a power supply 280, a rain detection device 291, a flow sensor 26, a pressure sensor 27 and a temperature sensor 28. Each of these components by itself is well known in the electronic industry, with the exception of the programming of the microprocessor in accordance with the functionality set forth herein.

It can be appreciated that the irrigation controller 20 can be a stand-alone device or a component of an integrated system. This would be especially true with some electronically controlled agricultural irrigation systems where most, if not all of the irrigation control functions are provided by a personal computer. Frequently with agricultural irrigation systems, there will be an irrigation controller 20 located at an irrigation site and a personal computer located at a house or office and either one or both can be used to control the irrigation system.

A class of irrigation systems, according to the present invention, comprises an irrigation controller and a plurality of water application devices. The irrigation controller at least partially controls the water application devices. A first communication system exchanges information between the irrigation controller and a distal computer and a second communication system exchanges information between the distal computer and a third party. Preferably, the user can exchange information with the irrigation controller and the distal computer. The exchange of information is preferably bi-directional. At least one of the communication systems may advantageously comprise a public, packet switched network, and more preferably comprises an Internet connection that makes use of a web page interface. One or more of the communication systems may involve a dedicated link. One or more of the communication systems may involve a pager, and especially a two-way pager. Microprocessors are advantageously included in at least the irrigation controller and the distal computer to facilitate the communications. The microprocessors may operate a RAM, ROM, or other data storage device.

A class of inventive methods according to the present invention include: utilizing the controller to at least partially control a plurality of water application devices; coupling an irrigation controller and a distal computer using a first communication system; a user communicating with an irrigation controller and entering irrigation operating information into the irrigation controller; and the irrigation controller causing at least a portion of the irrigation operating information to be transmitted to a distal computer using the first communication system.

An irrigation controller may advantageously comprise a microprocessor programmed to receive information from a distal computer and/or local water usage data from local sensors. Such microprocessor may be used to derive an irrigation schedule, and to communicate with a personal computer, and/or a distal computer. An irrigation schedule may advantageously involve computing a desired quantity of water to be applied to an irrigated area for a day, week, month, or other specific period of time. A preferable irrigation schedule is derived from stored information, inputted information, and/or received information. Such information may include local water usage data, such as water flow and water pressure. Additionally, information may include weather data, such as, temperature, solar radiation, wind and relative humidity. Furthermore, information may include at least one of the following: soil properties of the irrigated site, topography data on the irrigated site, size of the irrigated area, drainage, current ET values, crop coefficient values, irrigation efficiency values, and so forth.

A preferable irrigation schedule is at least partly based on ET data. Microprocessors disposed in either the irrigation controller, personal computer of the user or the distal computer will either receive a current ET value, calculate an ET value from current weather data or use a historical ET value. Weather data, used in calculating the ET value, is preferably from at least one of the following; temperature, humidity, solar radiation and wind.

It is contemplated that the ET value or weather data used in calculating the ET value will be received by the microprocessor via the Internet or some other public packet switched network. However, the ET value or weather data used in calculating the ET value may be received via a telephone line, radio, pager, two-way pager, cable, and any other suitable communication mechanism. It is also contemplated that the microprocessor 220 disposed in the irrigation controller or personal computer of the user may receive the weather data, used in calculating the ET value, directly from sensors, such as the temperature sensor 28, FIG. 3, at the irrigation site. The ET value is used to at least partly derive the irrigation schedule, and such ET value is contemplated to be a current ET value (i.e. within the last two weeks). It is more preferred, however, that the current weather information is from the most recent few days, and yet more preferred that the current weather information is from the current day. Regardless, ET values may be pre-calculated ET values received by the microprocessor 220 or estimated ET values calculated by the microprocessor 220 from weather data received by the microprocessor 220. The ET value may also be a historical ET value that is stored in the memory 210 of the irrigation controller, personal computer of the user or distal computer.

In a preferred embodiment a desired rate of water application is determined based at least partly on the ET value and is compared to the actual water applied to the irrigated area.

Preferably, a user exchanges information with the distal computer. Additionally, distal computers may communicate with a third party. The third party may thereby be apprised of many different types of information, including a calculated estimate of water actually applied at an irrigated area for a time period, and a relationship between the calculated estimate of water actually applied at a irrigated area for a time period and a computed rate of water application based at least in part on an ET value for the irrigated area for the same time period.

Normal, or at least predetermined, operating parameters may be implemented with warnings being provided to the user or to third parties when operating conditions fall outside the predetermined parameters. In some instances one or more of the microprocessors may be used to prevent an operation of the irrigation system when the irrigation system falls outside of the predetermined parameters.

Thus, specific systems and methods of interactive irrigation systems have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. An irrigation system comprising:
each of an irrigation controller and a water application device physically situated at a location of a user, the irrigation controller at least partially controlling the water application device;
a distal computer remote from the user location;
a first communication system that exchanges information between the irrigation controller and the distal computer;
a second communication system that exchanges information between the distal computer and a third party;
wherein the first communication system and the second communication system, comprise a public, packet switched network that may temporally include the distal computer; and
the user can exchange information with the irrigation controller and the distal computer.

2. The irrigation system of claim 1, wherein the exchange of information is bi-directional.

3. The irrigation system of claim 1, further comprising a microprocessor disposed in the irrigation controller that facilitates the exchange of information between the irrigation controller and the distal computer.

4. The irrigation system of claim 1, further comprising a microprocessor disposed in a second unit separate from the irrigation controller that facilitates the exchange of information between the irrigation controller and the distal computer.

5. The irrigation system of claim 1, further comprising a storage device located in the irrigation controller 6. The irrigation system of claim 1, wherein the user can exchange information with at least one of the irrigation controller and the distal computer through a public, packet switched network.

7. The irrigation system of claim 1 wherein the first communication system comprises a two-way pager.

8. The irrigation system of claim 1 wherein the first communication system comprises a web page interface.

9. The irrigation system of claim 1, further comprising a dedicated link between the irrigation controller and a personal computer.

10. The irrigation system of claim 1, wherein the water application device comprises a residential water application device.

11. The irrigation system of claim 1, wherein the water application device comprises an agricultural water application device.

12. A method of operating an irrigation system comprising:
utilizing an irrigation controller to at least partially control a water application device;
providing a first communication system comprising a public packet switched network;
coupling the irrigation controller and a distal computer using the first communication system;
the user entering irrigation operating information into the irrigation controller; and
the irrigation controller causing at least a portion of the irrigation operating information to be transmitted to the distal computer using the first communication system.

13. The method of claim 12 wherein the step of entering the irrigation operating information comprises the user entering the irrigation operating information into a personal computer and the personal computer transmitting the information to the irrigation controller.

14. The method of claim 12, further comprising:
providing the irrigation controller with a microprocessor programmed to receive additional information from the distal computer via the first communication system; and
the microprocessor determining an irrigation schedule based at least in part on the irrigation operating information from the user, and the additional information from the distal computer.

15. The method of claim 14, further comprising:
providing the irrigation controller with local water usage data; and
the microprocessor determining an irrigation schedule based at least in part on the water usage data.

16. The method of claim 15 wherein the step of determining an irrigation schedule further includes the microprocessor computing a desired quantity of water to be applied to an irrigated area for a specific period of time.

17. The method of claim 16 wherein the period of time is at least one day.

18. The method of claim 14 wherein the additional information from the distal computer may include weather data, evapotranspiration (ET) values, crop coefficient values, and irrigation efficiency values.

19. The method of claim 14 further comprising the microprocessor disposed in the irrigation controller computing an ET value.

20. The method of claim 19 further comprising the microprocessor comparing the ET value to the actual quantity of water applied to the irrigated area.

20. The method of claim 15, wherein the water usage data includes water pressure data.

21. The method of claim 14, further comprising coupling the distal computer and a third party using a second communication system.

22. The method of claim 14, further comprising the user exchanging information with the distal computer;

23. The method of claim 14 further comprising the microprocessor sending a warning to the user, when an aspect of the irrigation system falls outside of predetermined parameters.

24. The method of claim 14 further comprising the microprocessor preventing an operation of the irrigation system when the irrigation system falls outside of the predetermined parameters.

25. The method of claim 14 wherein the information transmitted to the distal computer comprises a calculated estimate of water actually applied at an irrigated area for a time period.

26. The method of claim 25 wherein the information transmitted to the distal computer further includes a relationship between the calculated estimate of water actually applied at an irrigated area, for a time period, and a computed ET for the same irrigated area, for the same time period.
